(19) United States
(12) Patent Application Publication
(10) Pub. No.: US 2012/0298437 A1
(43) Pub. Date: Nov. 29, 2012

(54) MOTORIZED APPARATUS AND MOMENT IMPARTING DEVICE

(76) Inventor: Scott Gregory Dietz, Hunt Valley, MD (US)

(21) Appl. No.: 13/578,487

(22) PCT Filed: Feb. 10, 2011
(86) PCT No.: PCT/US11/24413

§ 371 Date: Aug. 10, 2012

Related U.S. Application Data
(60) Provisional application No. 61/303,164, filed on Feb. 10, 2010.

(51) Int. Cl. G01C 19/02; F16H 59/00; B62M 9/00; B62K 11/00

(52) U.S. Cl. 180/219; 180/338; 74/5.22

(57) ABSTRACT

A combination motorized and propelled apparatus and moment imparting device is provided to improve the stability of the apparatus in motion with regard to pitch, roll and yaw. The moment imparting device uses one or more rotational members rotating around one or more axes to create a net rotational moment force around a desired axis of rotation. The moment imparting device is in communication with the motorized apparatus to translate that moment force to the motorized apparatus to improve stability or induce a desired rotation.

### CROSS REFERENCE TO RELATED APPLICATIONS

The present invention claims priority to co-pending U.S. Provisional Patent Application No. 61/303,164 filed Feb. 10, 2010. The entire disclosure of that application is incorporated herein by reference.

### FIELD OF THE INVENTION

The present invention, relates to devices for imparting moments about an axis.

### BACKGROUND OF THE INVENTION

Motorized or propelled apparatus moving across a surface, for example, cars, trucks and motorcycles moving across the ground and apparatus moving through a fluid medium, for example, airplanes, helicopters, surface water vessels, underwater vessels and jumping motorcycles, require stability while moving across these surfaces or through the associated fluid medium (air or water). The desired stability is typically provided through the shape of those apparatus, e.g., the location of the center of mass, and passive or active systems incorporated into those apparatus, e.g., stabilizing wings. Apparatus that have size and weight restrictions, for example, airplanes, spacecraft and jet packs, are limited in the systems that can be incorporated for stability control. In addition, the stability measures provided in the shape and systems of the apparatus often do not provide sufficient stability for the apparatus or are not applicable when the apparatus is operated at the limits of its intended operating range.

An example of a motorized apparatus that is operated at the limits of its intended operating environment is a motorcycle performing jumps and other aerial tricks as found, for example, in the field of freestyle motocross (FMX). The primary motorized apparatus in FMX is an off-road motorcycle or dirt bike. A dirt bike is a motorcycle specifically engineered to handle rough, off-road terrain and is provided with a very soft suspension with a lot of travel. A conventional motorcycle intended for use on paved roads has a completely different set up. These dirt bikes have been used for at least 60 years to perform feats including long jumping, popularized by riders such as Evel Knievel. For the past decade or two, the art of jumping motorcycles has evolved to include trick jumping.

Long jumping involves seeing how long of a distance a rider can jump the dirt bike and land without crashing. To date, the longest jump on a dirt bike is 351′ by Australian Robbie Maddison. To jump a dirt bike that far and to land safely, the rider effectively flies the dirt bike and utilizes forces provided by the rotation of the existing front and rear wheels of the dirt bike while in motion. In the air, the rider touches the rear brake, stopping the rotation of the rear wheel. The result of stopping the rear wheel rotation is to pitch the rear end of the dirt bike upward. Conversely, the rider can increase the throttle, increasing the rotational speed of the rear wheel and pitching the rear end of the dirt bike downward. These adjustments are made in an effort to gain the right landing attitude for the bike. As with the rear wheel, rotation of the front wheel is slowed or stopped in flight to pitch the front end of the dirt bike upward. By steering the handlebars to either the left or the right while in the air, the rider produces a powerful yaw response from the dirt bike. This yaw response is often referred to as a whip. In combination with forces generated by the rotation of the front wheel, these handlebar movements pull the entire dirt bike in the direction of the steer. When the front wheel is not spinning, those handlebar motions do not impart this pull on the dirt bike.

The sport of trick jumping has evolved to include flipping the dirt bike backwards while in the air. This includes single back flips and double back flips. Attempts have also been made to rotate the bike an entire 360° while in the air, i.e., a full 360° yaw. The desire is to perform aerial maneuvers of increasing complexity and difficulty. Such aerial maneuvers necessitate rotation of the bike around one or more axes, i.e., pitch, roll and yaw. Conventionally, the riders of dirt bikes only use the existing components of a dirt bike to achieve the desired aerial maneuvers. Modifications to dirt bikes have focused on making the suspension tougher for the hard landings, increasing the power from the engine and modifying the gear box for a more appropriate traction or speed. These changes, however, do not provide improvements for the aerial maneuvers.

Therefore, devices are needed to improve the maneuverability and stability of motorized vehicles, such as dirt bikes, during routine and non-routine operation. These devices would improve on the stability and maneuverability available from convention arrangements and rider operation.

### SUMMARY OF THE INVENTION

The present invention is directed to methods and systems for improving the stability and maneuverability of motorized apparatus during routine and nonroutine operation. These motorized apparatus or vehicles include cars, trucks, motorcycles (street bikes and dirt bikes), all terrain vehicles, remote control vehicles, scooters, snowmobiles, airplanes, drones, helicopters, personal propulsion devices such as jetpacks, spacecraft, surface water vehicles and underwater vehicles (manned and unmanned), among others. Suitable systems in accordance with the present invention can also be used with non-motorized apparatus such as bicycles and with human beings, e.g., gymnasts and acrobats. Capitalizing on the fact that every action produces an equal and opposite reaction, exemplary embodiments in accordance with the present invention utilize the rotation about a plurality of axes of one or more weighted members, for example weighted wheels, weight dumbbells or weight spheres. These axes are either part of or attached to the motorized apparatus to translate moments about those axes to the motorized apparatus and to control the resultant stability or rotation of that motorized device in one or more directions, i.e., pitch, yaw and roll.

The mass, speed of rotation, direction of rotation and moment arm associated with each one of the weighted members are controlled either together or individually to affect the resultant moment force that is generated and therefore the resulting pitch, roll and yaw of the motorized apparatus to which the weighted members are attached. Therefore, the motorized apparatus can be placed at the proper attitude for flight, can be induced into a desired maneuver and can be adjusted for a proper attitude for landing. A proper attitude for flying and landing can then be routinely and consistently achieved. In addition, in flight maneuvers that were impossible using conventional equipment and techniques, for example, multiple flips and combination maneuvers can be achieved.

In accordance with one exemplary embodiment, the present invention is direction to a motorized apparatus with momentum that include a motorized apparatus having a frame, a motor mounted on the frame and a propulsion mechanism supported by the frame and in communication with the motor. The propulsion mechanism derives power from the motor sufficient to propel the motorized apparatus. In one embodiment, the motorized apparatus is an automobile, a truck, a motorcycle, an all terrain vehicle, a remote control vehicle, a scooter, a snowmobile, an airplane, a drone, a helicopter, a jetpack, a spacecraft, a surface water vehicle or an underwater vehicle.

Also included is a moment imparting device that is in communication with the motorized apparatus and is configured to impart rotational momentum to the entire motorized apparatus. This moment imparting device is independent of and separate from the propulsion mechanism, i.e., wheels and drive train, of the motorized apparatus. In one embodiment, the moment imparting device is attached to the frame of the motorized apparatus and is centered on the center of mass of the motorized apparatus. A suitable arrangement for the moment imparting device includes a rotational axis member, at least one rotational member configured to rotate around the rotational axis member and a rotation inducing mechanism configured to induce rotation of the rotational member about the rotational axis member. Alternatively, the moment imparting device uses a plurality of mutually perpendicular rotational axis members and a plurality of rotational members where each rotational member is configured to rotate around one of the plurality of rotational axis members and each rotational axis member has at least one associated rotational member.

In one embodiment, the rotation inducing mechanism utilizes the motor of the motorized apparatus for each mechanical or electric power. In one embodiment, the rotation inducing mechanism comprises an electro-magnetic mechanism. In one embodiment, the rotational axis member is a portion of the frame of the motorized apparatus. In general, the rotational member contains a sufficient amount of mass to generate a sufficient amount of rotational momentum force upon rotation around the rotational axis member to impart rotational momentum to the entire motorized apparatus.

In another arrangement, the moment imparting device has a housing attached to the frame of the motorized apparatus, a spherical mass disposed within the housing and capable of freely rotating within the housing around any diametric axis of the spherical mass and a rotation inducing mechanism configured to induce rotation of the spherical mass within the housing around any selected diametric axis. In one embodiment, the housing is moveably attached to the frame of the motorized housing. In one embodiment, the rotation inducing mechanism includes a plurality of drive wheels rotationally supported in the housing and in contact with the spherical mass. Each drive wheel is configured to rotate the spherical mass around a distinct diametric axis. Also included is a control mechanism in communication with each drive wheel and configured to rotate the drives wheels are predetermined speeds to produce a net rotation in the spherical mass about a desired diametric axis. In one embodiment, the plurality of drive wheels is two drive wheels configured to rotate the spherical mass around two distinct and perpendicular diametric axes.

The momentum imparting can also include sensors to monitor rotation of the motorized apparatus about at least one axis and a control mechanism to configure the moment imparting device to impart a desired induce rotational momentum to the entire motorized apparatus based on the monitored rotation.

Exemplary embodiments of the present invention are also directed to a motorized apparatus with moment imparting device where the motorized apparatus is a motorcycle having a frame, a motor mounted on the frame and a propulsion mechanism supported by the frame and in communication with the motor. This propulsion mechanism includes two wheels and a drive chain and derives power from the motor sufficient to propel the motorcycle. Also includes is a moment imparting device attached to the frame of the motorcycle and configured to impart rotational momentum to the entire motorcycle. This moment imparting device is independent of and separate from the propulsion mechanism of the motorcycle.

In one embodiment, the moment imparting device is moveably attached to the frame of the motorcycle and also includes sensors to monitor rotation of the motorcycle about at least one axis and a control mechanism to configure the moment imparting device and to move the moment imparting device relative to the motorcycle frame to impart a desired induced rotational momentum to the entire motorcycle based on the monitored rotation. In one embodiment, the moment imparting device is centered on the center of mass of the motorcycle.

In one embodiment, the moment imparting device includes a plurality of mutually perpendicular rotational axis members and a plurality of rotational members. Each rotational member is configured to rotate around one of the plurality of rotational axis members, and each rotational axis member has at least one associated rotational member. Also included is a rotation inducing mechanism configured to induce rotation of the rotational members about the rotational axis members. In another embodiment, the moment imparting device includes a housing attached to the frame of the motorcycle, a spherical mass disposed within the housing and capable or freely rotating within the housing around any diametric axis of the spherical mass and a rotation inducing mechanism configured to induce rotation of the spherical mass within the housing around any selected diametric axis.

### BRIEF DESCRIPTION OF THE DRAWINGS

FIG. 1 is an illustration of an embodiment of a motorized apparatus and moment imparting device in accordance with the present invention;

FIG. 2 is an illustration of an embodiment of the components of a moment imparting device;

FIG. 3 is an illustration of an embodiment of an arrangement of rotational members for use in a moment imparting device;

FIG. 4 is an illustration of an embodiment of a rotational member for use in the moment imparting device;

FIG. 5 is an illustration of another embodiment of the moment imparting device in contact with the frame of a motorized apparatus;

FIG. 6 is a schematic illustration of another embodiment of a moment imparting device for use in accordance with the present invention;

FIG. 7 is a schematic representation of another embodiment of a motorized apparatus and moment imparting device in accordance with the present invention; and

FIG. 8 is an illustration of another embodiment of the moment imparting device in contact with the frame of a motorized apparatus.

### DETAILED DESCRIPTION

Exemplary embodiments of the present invention are directed to systems and methods for imparting and controlling moments, i.e., moments of force, about one or more axes of an apparatus, i.e., an apparatus that moves through a three dimensional space. Therefore, the controlled forces are rotational forces about the axes. In one embodiment, the axes are three mutually perpendicular axes as represented, for example, by a Cartesian coordinate system and expressed, for example, by the concepts of pitch, roll and yaw. Suitable systems and methods in accordance with the present invention communicate or transfer moments imparted around the axes of a separate moment imparting device to an apparatus. Suitable apparatus include non-motorized apparatus and motorized apparatus, i.e., apparatus that move or are propelled through the three dimensional space under the power of an engine or motor. Suitable motorized apparatus include vehicles including, but not limited to, automobiles, trucks, motorcycles (street bikes and dirt bikes), all terrain vehicles (ATVs), remote control vehicles (RC vehicles), scooters, snowmobiles, airplanes, drones, helicopters, personal propulsion devices such as jetpacks, spacecraft, surface water vehicles and underwater vehicles (manned and unmanned).

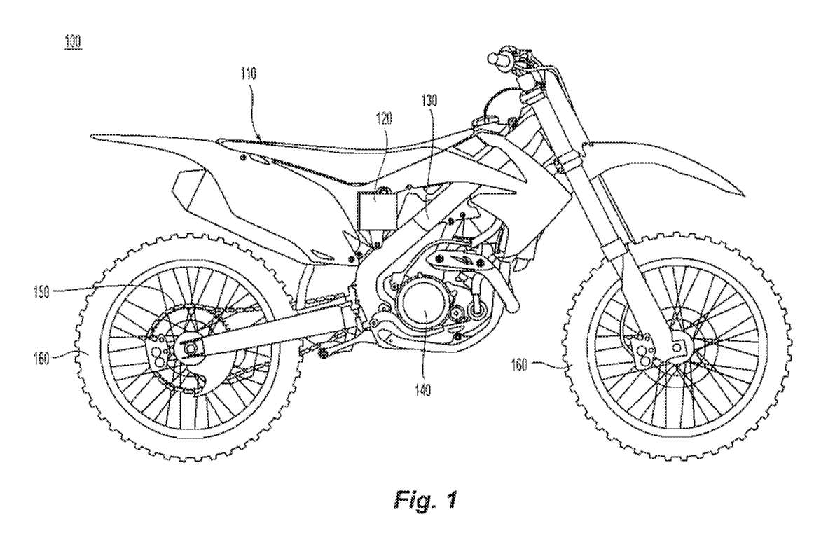

Referring initially to FIG. 1, in one exemplary embodiment in accordance with the present invention, the present invention is direct to a combination of a motorized apparatus and moment imparting device 100. As illustrated in FIG. 1, the motorized apparatus 110 is a motorcycle; however, any suitable motorized apparatus can be used. The motorized apparatus 110 includes a frame 130 that is typically constructed from a plurality of interconnected frame members and at least one motor 140 mounted on the frame 130. The motorized apparatus 110 also include a propulsion mechanism supported by the frame and in communication with the motor. In general, the propulsion mechanism derives power from the motor that is sufficient to propel the motorized apparatus across the desired surface or through the desired fluid medium, e.g., air, water or space. The propulsion mechanism is constructed based on the environment in which the motorized apparatus operates. For a motorcycle, the propulsion mechanism includes two wheels 160 and a drive train 150 such as a chain that is in communication with the engine. Other components can also be considered as part of the propulsion mechanism, for example a transmission.

The moment imparting device 120 is provided in communication with the motorized apparatus and is configured to impart rotational momentum or rotational moments around one or more axes of the entire motorized apparatus. In one embodiment, the moment imparting device 120 is attached to one or more of the frame members that constitute the frame 130 of the motorized apparatus. Any suitable method for attaching devices together can be used including adhesives, fasteners and welds. In one embodiment, the moment imparting device 120 is fixedly secured to the motorized apparatus at a desired location. Suitable locations include at the center of mass of the motorized vehicle, i.e., the center of mass of the moment imparting device coincides with the center of mass of the motorized apparatus, and at locations other than the center of mass, for example adjacent one of the wheels in the propulsion mechanism or along a center line of the motorized apparatus. In one embodiment, the moment imparting device is moveably or adjustably mounted to the frame of the motorized apparatus. Therefore, the location of the moment imparting device can be adjusted along the frame members, for example, relative to the center of mass, from side to side or from front to back. Preferably, the moment imparting device is independent of and separate from the propulsion mechanism of the motorized apparatus. Although illustrated as a single moment imparting device, a given moment imparting device can be arranged as a plurality of separate moment imparting devices, one each of a given axis of rotation. Each separate moment imparting device could be attached to the motorized apparatus at a different location. In another embodiment, a plurality of identical moment imparting devices is attached to the motorized apparatus, for example at a plurality of distinct locations.

The moment imparting device produces a net rotational momentum around a desired axis of the moment imparting device and, therefore, to the motorized apparatus to which the moment imparting device is attached. In one embodiment, this desired axis is the intended axis of rotation for the entire motorized apparatus. Therefore, the net rotational momentum of the moment imparting device is communicated to or transferred to the entire motorized apparatus, yielding the desired rotation in the motorized apparatus. This desired rotation can produce movement in the motorized device such as a roll or flip at a desired speed of rotation or can produce a rotational force that is used to counter undesired rotation, i.e., roll, flip and yaw, in the motorized apparatus. In this later case, the net rotational momentum acts as a corrective or stabilizing force.

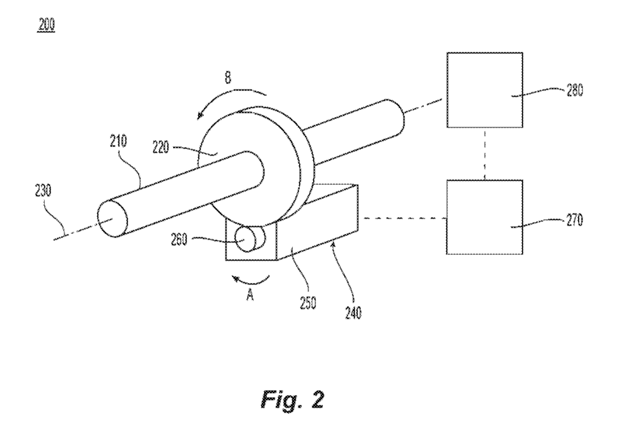

Referring to FIG. 2, an embodiment of the moment imparting device 200 is illustrated. The moment imparting device 200 includes a rotational axis member 210 and at least one rotational member 220 that is configured to rotate around the rotational axis member. In one embodiment, these members are contained within and in communication with a housing or container (not shown) that is attached to the motorized apparatus. Although a single rotational member is illustrated, in other embodiments, two or more rotational members are provided for rotation around a given rotational axis member. In this embodiment with a single rotational axis member, the rotational axis member runs along or is parallel to the axis 230 around which rotational momentum and therefore rotation of the motorized apparatus is desired. In one embodiment, the rotational axis member is a portion of the frame of the motorized apparatus. In this embodiment, multiple combinations of rotational axis members that are portions of the frame of the motorized apparatus and rotational members can be provided at different locations on the frame of the motorized apparatus. Therefore, the resultant rotational momentum imparted to the motorized apparatus is the resultant moment forces of all of the rotational axis member and rotational member pairs.

In one embodiment, the rotational members are attached to the rotational axis members so as to rotate freely around the rotational axis members without rotating the rotational members. However, the resultant moment forces are transferred to the motorized apparatus. This embodiment is desired, for example, when the rotational axis members are portions of the frame of the motorized apparatus. In another embodiment, the rotational axis members rotate with the rotational members. This embodiment can be used when the rotational axis members are contained within a housing of the moment imparting device that is attached to the motorized apparatus. In addition, this embodiment facilitates the use of the rotational axis members to be used in imparting or driving the rotation to the rotational members.

The rotational members represent a rotating mass about the rotational axis members and are configured to provide both the desired mass and the desired moment arm for producing a sufficient moment force. The determination of the necessary mass and moment arms to create a desired moment force about a desired axis or point of rotation is understood by one of skill in the art. In general, the rotational member has a sufficient amount of mass to generate a sufficient amount of rotational momentum force upon rotation around the rotational axis member to impart the required rotational momentum to the entire motorized apparatus. The necessary mass and moment arms can be set or can be adjustable.

The moment imparting device includes a rotation inducing mechanism 240 in communication with the rotational members. The rotation inducing mechanism is configured to induce rotation of the rotational member about the rotational axis member. As illustrated, the rotation inducing mechanism includes a motor 240, for example an electric motor, and at least one drive wheel 260 that is in communication with the motor 240 and is driven by the motor 240. The drive wheel 260 is in communication with the rotational axis member or rotational member 220 such that rotation of the drive wheel in a given direction A produces rotation of the rotational member in a resulting direction B. The rotation inducing mechanism can also include other components such as pulleys and gears to produce the desired rate of rotation and to communicate the rotation to one or more rotational members. In one embodiment, the rotation inducing mechanism includes or utilizes the motor of the motorized apparatus to derive either mechanical or electric energy. Other suitable rotation inducing mechanism can utilize electro-magnetic mechanisms to induce rotational motion in the rotational member.

The moment imparting device also includes a control mechanism 270. Suitable control mechanisms include programmable logic controllers and other types of computerized or computer based controllers. This control mechanism controls the operation of the moment imparting device including the speed at which the rotational member rotates, the direction of rotation and the length of the moment arm, among other factors. The control mechanism can also affect the resultant composite axis of any rotational momentum created by the moment imparting device, for example, by controlling the location of the moment imparting device relative to the frame of the motorized apparatus, the rotational speed of the rotational members and the direction of rotation of the rotation members. In one embodiment, the control mechanism is in communication with the rotation inducing mechanism, for example the motor of the rotation inducing mechanism. Therefore, the control mechanism can control the speed of rotation and direction of rotation of the motor. In one embodiment, the control mechanism is part of the same control mechanisms and computer controls of the motorized apparatus. Alternatively, the control mechanism is separate from any systems of the motorized apparatus; however, the control mechanism may be in communication with computers and sensors of the motorized apparatus.

The moment imparting device can also include a plurality of sensors 280, either unique to the moment imparting device or part of the motorized apparatus, to monitor conditions of the motorized apparatus including the current rotation of the motorized apparatus about at least one axis. The sensors are in communication with the control mechanism and the two components work together to configure the moment imparting device to impart a desired induced rotational momentum to the entire motorized apparatus based on the monitored conditions of the motorized apparatus including monitored speed, height, center of mass, pitch, roll and yaw. The moment imparting device can also include additional input and output devices (not shown) to facilitate operator input to the control mechanism and operator monitoring of the moment imparting device. Suitable input and output devices to a computerized control mechanism are known and available to one of skill in the art. In one embodiment, these additional input and output devices include, but are not limited to, additional switches, levers, lights, display screens, touch screens, joysticks, speakers, microphones and remote control devices. These devices can be held by the operator or integrated into the motorized apparatus. In another embodiment, the additional input and output devices include the existing controls and systems of the motorized apparatus including, but not limited to, brake pedals and brake levers, throttles, navigation screens, steering wheels, handle bars, control sticks and clutch pedals or clutch levers. In one embodiment, the moment imparting device also includes telemetric communication capabilities for monitoring and control of the moment imparting device including WIFI, Bluetooth, Infrared and Cellular Network communication capabilities.

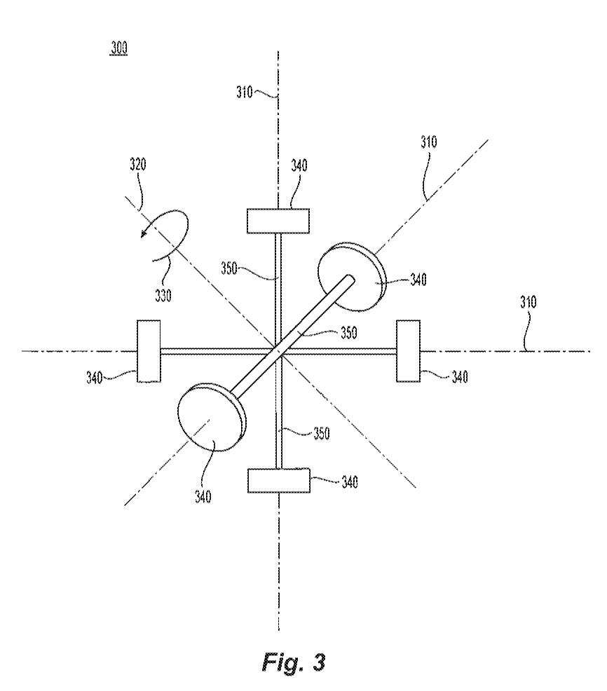

Referring to FIG. 3, in another embodiment, the moment imparting device 300 utilizes a combination of multiple sets of rotational axis members and rotational members. In this embodiment, the various combinations of rotational axis members and rotational members can be independently controlled to produce and overall resultant rotational momentum around a desired rotational axis. The amount of momentum force, the direction of that force and the location of the rotational axis can all be controlled and modified as desired. Therefore, a motorized apparatus can be initially induced to flip and then to stop flipping or to flip in the opposite direction. In addition, more complicated motion can be induce in the motorized apparatus such as a combination flip and roll. Also, this embodiment can be adjusted in real time to compensate for whatever net pitch, roll and yaw forces are currently acting on the motorized apparatus. In this embodiment, a plurality of axes 310 are identified for location of each one of the rotational axis member and rotation member combinations. As illustrated, three axes are identified corresponding to the three mutually perpendicular axes of the Cartesian coordinate system. The moment imparting device, however, can utilize rotational axis members around only two axes or can utilize them around more than three axes. When the moment imparting device is installed on a motorized apparatus, these axes can be set to align with the pitch, roll and yaw axes of the apparatus or can be align randomly with regard to the axes of the motorized apparatus. In this later embodiment, the moment imparting device is calibrated to the pitch, roll and yaw axes of the motorized apparatus.

As illustrated, the moment imparting device includes a plurality of mutually perpendicular rotational axis members 350 each aligned along one of the plurality of rotational axes. In addition, the moment imparting device includes a plurality of appropriately weighted rotational members 340. Each rotational member is configured to rotate around one of the plurality of rotational axis members, and each rotational axis member has at least on associated rotational member. As illustrated, each rotational axis member has two associated rotational members attached, for example, at either end of the rotational axis member in a dumbbell arrangement. In this embodiment, the combinations of rotational members and rotation axis members are identical; however, varied combinations can be used in a given moment imparting device. This embodiment of the moment imparting device will also include one or more momentum inducing devices, a control system, sensors and input and output devices as describe herein to control the rotation of each combination of rotational members and rotational axis member to produce the desired net rotational momentum 330 around the desired rotational axis 320. This net rotational momentum is communicated to the motorized apparatus, for example by direct contact with the rotational axis members or by contact with a housing or frame of the moment imparting device that supports the rotational axis members.

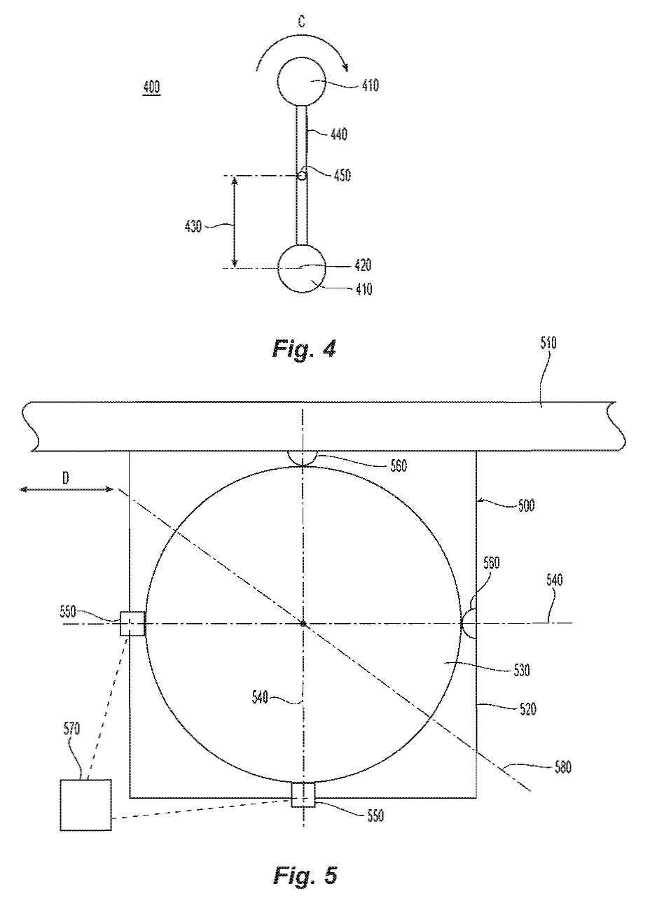

Embodiments of the moment imparting device of the present invention can use various arrangements of rotational members. For example, the rotational members can be arranged as rings having the desired thickness, as measured extending from the rotational axis member, and mass. The mass can be evenly distributed through the ring or can be concentrated at a given location in the ring, i.e., to define a length of moment arm. Referring to FIG. 4, in one embodiment, the rotational member 400 is arranged as a pair of separate opposing masses 410 connected by an arm 440 that is in communication with the rotational axis member 450. The desired mass of the rotational member is provided in the two opposing masses. Alternatively of plurality of opposing mass pairs and connecting arms can be used. The moment arm 430, i.e., the length from the rotational axis member 450 to the center of each opposing mass 420, of the rotational member 400 is set in accordance with the desired rotational moment achieved by rotation of the opposing masses around the rotational axis member 450 for example in the direction illustrated by arrow C. In one embodiment, the length of the moment arm is adjustable to adjust the resultant moment for the same size mass. This adjustment can be made manually using for example a threaded or otherwise adjustable connection in the arm. Suitable length adjustment mechanisms are known and available in the art. In one embodiment, adjustment of the moment arm is made in real time based on the current operating conditions of the motorized apparatus and the desired or required rotational moments. Adjustable moment arms can be applied to any embodiment of rotational members in accordance with the present invention.

The proceeding embodiments illustrate the use of a single rotational member to induce momentum around a single fixed axis and the use of multiple rotational members to induce moments around multiple fix axes to produce a net resultant rotational momentum force around a desired resultant axis. In another embodiment, a single rotational member is used to produce a net resultant rotational momentum force around a desired, i.e., not fixed, axis. Referring to FIG. 5, an embodiment of a moment imparting device 500 attached to a portion of the frame 510 of a motorized apparatus is illustrated. In this embodiment the moment imparting device includes a housing 520 that is attached to the frame 510 of the motorized apparatus. This housing can be fixedly attached or moveably attached. The moveably attached housing can be moved relative to the frame 510, for example in the direction indicated by arrow D. This allows for adjustment of the location of the moment imparting device with regard to the center of mass of the motorized apparatus.

A spherical mass 530 is disposed within the housing and capable or freely rotating within the housing around any diametric axis of the spherical mass. The spherical mass 530 is constructed with a sufficient amount of mass and having a sufficient diameter to yield the desired momentum. This mass can be evenly distributed throughout the sphere or can be concentrated at different points along the radius of the sphere. The moment imparting device also includes a rotation inducing mechanism configured to induce rotation of the spherical mass within the housing around any selected diametric axis. In one embodiment, the rotation inducing mechanism includes a plurality of drive wheels 550 rotationally supported in the housing and in contact with the spherical mass. Each drive wheel is configured to rotate the spherical mass around a distinct diametric axis 540. A control mechanism 570 is provided in communication with each drive wheel and is configured to rotate the drives wheels at predetermined speeds and directions to produce a net rotation in the spherical mass about a desired diametric axis 580. In one embodiment, the plurality of drive wheels are two drive wheels configured to rotate the spherical mass around two distinct and perpendicular diametric axes. Other embodiments can utilize three, four or more drive wheels. In one embodiment, three drive wheels aligned to spin the sphere around three mutually perpendicular diametric axes are used. The drive wheels can be fixed or moveable. A single drive sphere in contact with the surface of the spherical mass can also be used. A plurality of spacers or bearing rollers 560 can also be provided between the housing and the spherical mass to aid in the rotation of the spherical mass and the positioning of the spherical mass within the housing.

Embodiments of the moment imparting device that utilize the weighted sphere in combination with a motorized apparatus that is in flight, airborne or otherwise moving through a fluid medium produce rotation in the motorized apparatus that is opposite in direction from the resultant or net rotational momentum of the sphere. In addition to the drive mechanisms for the sphere discussed above, a plurality of bars can be used that run across the sphere and touch at one point. For example, the bars would each be aligned tangent to the surface of the sphere, touching the sphere at separate and distinct points along its surface. Suitable arrangements of drive bars utilize, two three, four or more drive bars in arrangements similar to those for the drive wheels. One or more motors, pulleys, belts and other drive mechanisms are used to rotate each one of the bars. Controlling the location, rotational direction and rotational speed of each bar produces rotation of the sphere around any diametric axis. The drive mechanisms can be located at each end of each bar to provide increased durability and stability to the drive mechanism.

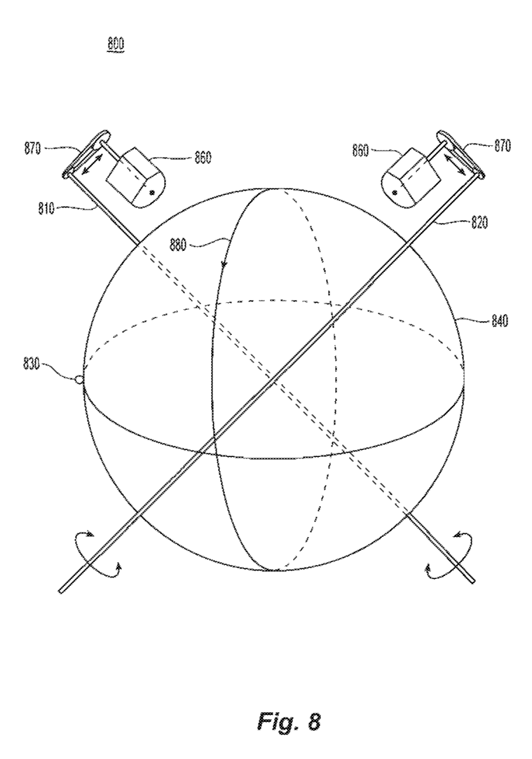

Referring to FIG. 8, an embodiment of a weight sphere and drive mechanism using a plurality of bars drive 800 is illustrated. As illustrated, three tangential bars are used, a first bar 810, a second bar 820 and a third bar 830. The third bar 830 is illustrated a passing perpendicularly through a plane represented by the sheet of paper. All three bars are in tangential contact with the surface of the weighted sphere 840 at distinct points on the surface. The bars rotate against the surface of the sphere and are spaced so as to be able to generate a net rotation 880 of the weighted sphere, and hence a net moment, around any desired diametric axis of the weighted sphere. Each bar can be driven by an electric motor 860 that is separately controlled in speed and rotational direction and is in contact with its associated bar either directly of through one or more pulleys 870.

The weighted sphere is able to rotate in any direction around any diametric axis. If the weighted sphere with an independent drive system is placed at the centerpoint or center of mass of a motorized apparatus, taking into account the weight of the apparatus and the operator, stability is imparted to the motorized apparatus either on the ground or moving through a fluid medium. While airborne, for example, the motorized apparatus can be placed in any position using the momentum force produce by the rotating weighted sphere. For example, a rider initiates a jump, turns the bike upside down, helicopters the majority of the way to the landing ramp, stops the yawing motion of the motorbike, rights the bike to a wheel down position, and then lands. While riding the motorized apparatus across a solid surface, the weighted sphere is rotated in the appropriate direction to correct any sideways leaning of the motorized apparatus or to correct any undesired or unsafe pitch or yaw.

In one embodiment, the motorized apparatus is a motorcycle such as a dirt bike. The center of mass of the motorcycle, including the weight of the rider, is determined and the moment imparting device is located on the motorcycle at the center of mass. In particular, the moment imparting device is centered on the center of mass of the motorcycle. For example, all of the rotational axis members pass through the center of mass or the spherical mass is centered on the center of mass. When a three axis moment imparting device is used, the three axes are aligned with the pitch, roll and yaw axes of the motorcycle. Therefore, one rotational member rotates in a plane parallel to the wheels of the motorcycle, and one rotational member rotates in a plane parallel to the ground. The third rotational member rotates in a vertical plane perpendicular to the ground and the plane in which the wheels rotate. All of the rotational members are in communication with appropriately sized electric motors to power their rotation.

Since every action or force produces an equal and opposite reaction, the rotational members are rotated in their respective planes in a direction opposite from the desired rotation of the motorcycle with respect to that same plane. For example, rotating the rotational member in the plane parallel to the wheels in a backwards direction will cause the bike to flip forward. Reversing the direction of rotation of the rotational member will slow, stop and if desired reverse the direction in which the motorcycle flips. Controlling the rotation of the other rotational members will yield similar rotation of the motorcycle around the associated axes. Combining the rotational momentum of the rotational members will yield more complex rotations in the motorcycle, for example, a combination front flip and barrel roll.

In addition to producing acrobatic maneuvers in the motorcycle, the rotational members can also be used strictly for stability when riding the motorcycle along the ground or jumping the motorcycle through the air. For example, on a long straight jump, undesirable pitch, roll and yaw is avoided so that the motorcycle stays true in flight. When the motorcycle falls out of prescribe parameters, for example when the motorcycle is no longer horizontal, the appropriate rotational members are rotated to put the bike back into the right attitude. In one embodiment, the motorcycle would include a controller, i.e., an input/output unit, built into the handlebars with features similar to those found in a typical game controller. For example, the controller can include a joystick, which would control the pitch and roll of the bike, and left and right buttons, which would control yaw. These devices could be positioned, for example, adjacent the rider's left hand for control using the left thumb, as the rider will need to hold on to the handlebars with both hands during flight. The controller sends appropriate commands to the control mechanism of the moment imparting device. The control mechanism interprets the input commands and relays the commands to the appropriate rotation inducing mechanism, for example one or more electric motors, effectively manipulating the attitude of the motorcycle in flight.

The control mechanism also monitors the orientation of the motorcycle at all times and other information such as the current distance of the motorcycle from the ground. These data are obtained using sensors including standard commercially available sensors. For example, motorcycle orientation is determined using one or more gyroscopes. Distance from the ground, or any other surface, can be determined using a sonar-based sensor system. In one embodiment, the control mechanism has a preprogrammed setting so that on every jump, the rider can release all manual controls, and the computer sets the bike into the right landing attitude. This setting can be modified based on the particulars of a given jump, distance, height and ambient conditions. In one embodiment, the control mechanism is preprogrammed with a plurality of different maneuvers. Suitable presets include multiple flips, barrel roll, a complete flat spin, and a landing. These presets could be tied together in series for a combination of maneuvers on a given jump. The control mechanism can also include a present safety mode that returns the motorcycle to a proper landing attitude if the present or desired maneuvers cannot be executed safely.

The size and mass of the rotational members are varied based upon the required rotational momentum in combination with space constraints. For example using multiple smaller rotational members along a given axis instead of just one larger rotational member will allow a better fit and accommodate multiple rotational members and rotational axis members in a given space. In one embodiment, the central axis, i.e., center of mass, of the motorcycle and rider is identified and an axle is passed through that central axis from left side to right side of the motorcycle. A weighted rotational member, for example in the form of a weighted wheel, is located on each side of the motorcycle. Two electric motors are provided, one each in contact with one of the rotational members to spin the rotational members independently from one another. The same control mechanism, sensors and input/output mechanism can be used as in other embodiments. Although this embodiment would work well to affect pitch, the roll and yaw of the motorcycle may not be as readily controlled. These limitations on the effectiveness of roll and yaw control can be addressed by allowing the axle to swivel side-to-side and up and down. In one embodiment, the axle swivels to move the rotational members either forward or backward, i.e., left to right model, or up and down through a rotational angle of up to about 45° either in unison or independent of each other, yielding greater roll and yaw control in the motorcycle.

Embodiments of the moment imparting device of the present invention increase the overall stability of motorcycles when trail riding or during casual pleasure rides. The momentum imparting system prevents the motorcycle going end over end or falling sideways, which are common dangers during any given outing. For instance, when a rider encounters a jump during trail riding, any wrong move can cause the motorcycle to land hard on either the front or rear tire and can result in a loss of control. The moment imparting device of the present invention automatically self adjusts the motorcycle for a safe landing.

Four wheel motorized apparatus such as all terrain vehicles, cars and trucks, including large four-wheel drive trucks referred to as monster trucks are increasingly used to perform aerial acrobatics that including jumping a significant distance. Recently, a car was jumped 269 feet to a successful landing. However, that car exhibited very limited control in flight. If the front end of the car started to pitch upward, the driver could pump the brakes to make the car nose down. Conversely, if necessary, the driver could increase the throttle to bring the car nose up. Turning the steering wheel may have yielded some degree of yaw response. Prevention or compensation for roll, however, was not available.

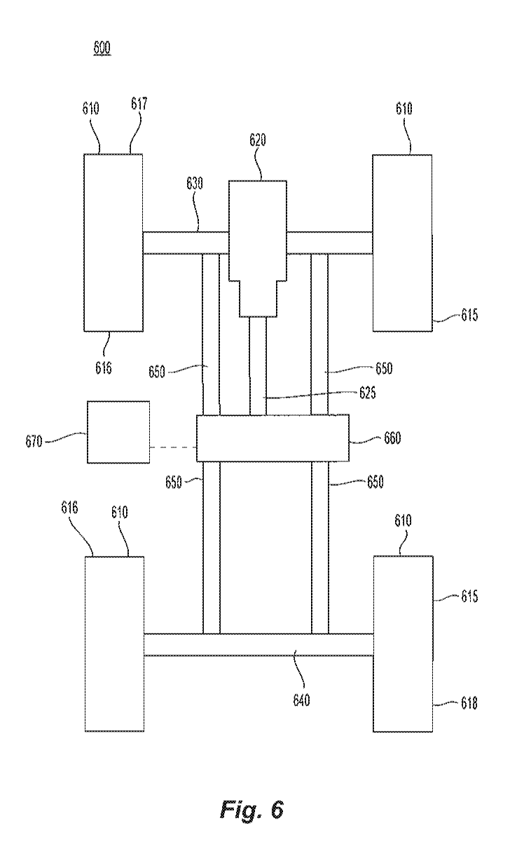

In one embodiment, the desired level of pitch, roll and yaw control and compensation is provided by incorporating the moment imparting device of the present invention into these motorized vehicles. In one embodiment, the moment imparting device takes advantage of controlling all four of the vehicles wheels independently. Therefore, the existing wheels are rotated independently in flight in either forward or a reverse direction to achieve greater stability. Referring to FIG. 6, an exemplary embodiment of a moment imparting device 600 utilizing the existing wheels of a multi-wheeled motorized apparatus is illustrated. As illustrated, the motorized apparatus is a car, truck or all terrain vehicle having four wheels 610. As illustrated, the motorized apparatus is a four-wheel drive vehicle. The motorized apparatus includes a motor 620 mounted on the frame of the motorized apparatus to provide the desired power to the wheels and the moment imparting device. A front axle 630 is in contact with a pair of front wheels, and a rear axle 640 is in contact with a pair of rear wheels. Power from the engine is transferred through a single main drive shaft 625 to a transmission and transfer case 660. The transmission and transfer case is modified to accommodate a plurality of separate secondary drive shafts 650. A single secondary drive shaft is associated with each wheel so that the speed and direction of each wheel can be independently controlled by the transmission and transfer case. The control mechanism 670 is in communication with the transmission and transfer case to control the desired speed and rotational direction in each wheel.

When the motorized apparatus exhibits an undesired roll in flight, the rotational direction and speed of the wheels are independently controlled. For example, the rotation of the right side wheels 615 is slowed or even reversed, and the rotation of the left side wheels 616 is increased. This induces a momentum in the motorized vehicle that counters the roll and returns the motorized vehicle to level or horizontal flight. If the left front corner of the motorized vehicle pitches downward while in the air, the rotational speed of the associated left front wheel 617 is increased while the rotational speed of the right rear wheel 618 is decreased. This will produce a resulting rotational momentum force that will level the motorized vehicle. This embodiment of the moment imparting device can also be used to increase agility in the air, i.e., to pitch or barrel roll the motorized apparatus. While in the air, if the two front wheels double their rotational speed while the direction of rotation of the rear wheels is reversed, the motorized apparatus will flip backwards. Reversing to the original rotation would right the motorized apparatus. Other embodiments of the moment imparting device of the present invention that utilizes the various rotational members can also be used either alone or in combination with the wheel control mechanism.

One embodiment that is particular well suited for the wheel rotation embodiment of the moment imparting devices is with large or oversized four-wheel drive trucks, known as monster trucks. As a general rule, monster trucks weigh approximately 9,000 lbs. Each wheel and tire weighs approximately 750 lbs. Therefore, the wheel and tires of a standard monster truck represent about ⅓ of the total weight of the vehicle. Therefore, these tires can be used to impart a significant amount of force on the entire monster truck. Monster trucks are routinely used to perform jumps, and the operator can either accelerate or hit the brakes while jumping to induce a desired motion in the truck. If the driver is nose down a little and wants to land on all four wheels equally, the driver hits the accelerator and the truck will nose down. Conversely, if the truck is a little nose up, the driver can hit the brake and bring the nose up. However, the front and rear sets of tires spin together, limiting the degree of control available to the drive.

Systems and methods in accordance with the present invention modify the transmission and transfer case and provide the necessary control mechanisms so that the truck's engine delivers different amounts of power to each wheel independently including reversing the direction of rotation of one or more wheels independent of the other wheels. If the driver takes off from a jump and goes airborne while accelerating the rotation of the wheels on only one side of the truck while simultaneously stopping and reversing the direction of rotation of the wheels on the other side of the truck, the truck will barrel roll while in the air. The barrel roll is stopped and the truck positioned for a proper landing by slowing the rotation of the wheels on the first side of the truck and stopping the backward rotation of the wheels on the other side of the truck and returning the rotation of those wheels to the same rotational speed at take off. Fine controls for placing the truck in the right landing attitude would be easily achievable as the driver or a computer controller could finely adjust the speed of all four tires to place the truck into the right attitude.

The momentum imparting system of the present invention can also induce back and front flips in a monster truck. This can also be accomplished without modification of the truck if after starting a jump of sufficient height and distance, the driver hit the brakes to bring the wheels to close to a dead stop and place the truck in reverse and accelerated the wheels. This would induce a front flip in the truck. To stop the flipping motion of the truck, the driver hits the brakes, places the truck in forward and rotates the wheels with a forward rotation.

Therefore, an exemplary embodiment in accordance with the present invention is direction to a system for controlling the rotation of a motorized apparatus that includes a motor, a transmission in communication with the motor and deriving rotational motion from the motor and a plurality of wheels used to propel the motorized apparatus. In one embodiment, the plurality of wheels includes four wheels. Each wheel is in communication with the transmission and derives rotational motion from the transmission. The transmission is configured to control rotational speed and rotational direction of each wheel separately from and independent of the other wheels. Therefore, this embodiment uses an independently controlled multi-wheel drive system. A control mechanism, such as an electronic or computer-based control mechanism, is also provided in communication with the transmission. This control mechanism is configured to use the transmission to separately and independently control the rotational speed and rotational direction of each wheel to impart a desired moment around a selected axis of rotation of the motorized apparatus. Therefore, independent rotational control of each wheel in a motorized apparatus such as a car or truck is used to impart moments to the motorized apparatus that can induce pitch, roll and yaw. The present invention is also directed to methods for using these systems to control the pitch, roll, yaw or stability of the motorized apparatus.

In one embodiment, the moment imparting device using the existing wheels of the motorized apparatus is extended to vehicles having two wheels. In this embodiment, the rotation of both the front and rear wheels of a motorcycle is utilized. For example, an auxiliary electric motor is placed in communication with the front wheel of a motorcycle to selectively spin that wheel in either a forward or reverse direction. This would yield increased control and stability to the motorcycle during jumps. In one embodiment, auxiliary electric motors are provided in communication with both the front and rear wheels. These motors can then selectively spin the wheels in either a forward or reverse direction and in a near frictionless environment when the motorcycle is passing through the air could spin the wheels at rotational speeds in excess of those provided by the motor and gearbox. This embodiment could yield multiple front and back flips, and flat spins or 360's.

If the motorcycle had both the front and rear wheels rotating in reverse, a front flipping motion is induce in the motorcycle. To pull out, the direction of rotation of the wheels is reversed, and the wheels are rotated at whatever rotational velocity is required to right the motorcycle. If the rotational speed of both wheels is merely increased while airborne, a back flip is induced. The rotation of the wheels is slowed, stopped or reversed to stop this back flip.

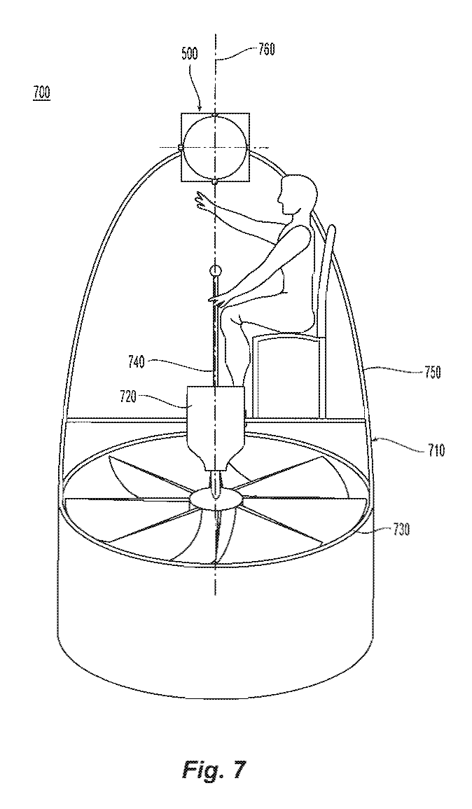

Referring to FIG. 7, another exemplary embodiment of a combination motorized apparatus and moment imparting device 700 in accordance with the present invention is illustrated. In this embodiment, the motorized apparatus is a manned flying apparatus 710, for example a floating apparatus or flying car. The motorized apparatus of this embodiment includes a motor 720 in communication with a levitation and propulsion mechanism 730. In one embodiment, the levitation and propulsion mechanism is a counter rotating turbo prop. A control lever 740 such as a control stick, handlebar or steering wheel is also provided in communication with the engine and propulsion mechanism. All of this is supported in the frame 740 of the motorized apparatus. The motorized apparatus can also include a seat for the driver, handlebars that can turn left or right to make the motorized apparatus turn in that direction or that can be pushed forward or backward to make the motorized apparatus move either forward or backward, a computer controller and redundancies at every critical facet of the machine. Also attached to and support by the frame 750 is a moment imparting device in accordance with the present invention. Any suitable embodiment of the moment imparting device can be used. In one embodiment, the moment imparting device utilizes the spherical mass or spherical inertial mass embodiment. This embodiment of the moment imparting device can be aligned with a central axis 760 of the motorized vehicle. A similar arrangement can also be provided in combination with a manned jetpack.

Motorized apparatus in accordance with this embodiment achieve the desired level of stability and provide maneuverability to an apparatus that has a propulsion system that provides thrust in only a single direction. Motion in other directions is achieved by generating an appropriate net rotation momentum force using the associated moment imparting device to place the motorized apparatus out of balance along the appropriate axis. The entire motorized apparatus will rotate accordingly, directing the unidirectional thrust along this tilted axis and moving the motorized apparatus along that tilted axis in a direction opposite the unidirectional thrust. This movement is slowed or stopped through adjustments to the moment imparting device that change the angle and location of the tilted axis. Stability is also achieved as the resulting moment force of the moment imparting device counteracts the roll of the motorized apparatus and returns the motorized apparatus to the upright position.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

What is claimed is:

1. A motorized apparatus with moment imparting device comprising:
a motorized apparatus comprising:
a frame;
a motor mounted on the frame; and
a propulsion mechanism supported by the frame and in communication with the motor, the propulsion mechanism deriving power from the motor sufficient to propel the motorized apparatus; and
a moment imparting device in communication with the motorized apparatus and configured to impart rotational momentum to the entire motorized apparatus;
wherein the moment imparting device is independent of and separate from the propulsion mechanism of the motorized apparatus.

2. The motorized apparatus with moment imparting device of claim 1, wherein the motorized apparatus comprises an automobile, a truck, a motorcycle, an all terrain vehicle, a remote control vehicle, a scooter, a snowmobile, an airplane, a drone, a helicopter, a jetpack, a spacecraft, a surface water vehicle or an underwater vehicle.

3. The motorized apparatus with moment imparting device of claim 1, wherein the moment imparting device is attached to the frame of the motorized apparatus and is centered on the center of mass of the motorized apparatus.

4. The motorized apparatus with moment imparting device of claim 1, wherein the moment imparting device comprises:
a rotational axis member;
at least one rotational member configured to rotate around the rotational axis member; and
a rotation inducing mechanism configured to induce rotation of the rotational member about the rotational axis member.

5. The motorized apparatus with moment imparting device of claim 4, wherein the moment imparting device further comprises:
a plurality of mutually perpendicular rotational axis members; and
a plurality of rotational members, each rotational member configured to rotate around one of the plurality of rotational axis members and each rotational axis member having at least one associated rotational member.

6. The motorized apparatus with moment imparting device of claim 4, wherein the rotation inducing mechanism comprises the motor.

7. The motorized apparatus with moment imparting device of claim 4, wherein the rotational axis member comprises a portion of the frame of the motorized apparatus.

8. The motorized apparatus with moment imparting device of claim 4, wherein the rotational member comprises a sufficient amount of mass to generate a sufficient amount of rotational momentum force upon rotation around the rotational axis member to impart rotational momentum to the entire motorized apparatus.

9. The motorized apparatus with moment imparting device of claim 4, wherein the rotation inducing mechanism comprises an electro-magnetic mechanism.

10. The motorized apparatus with moment imparting device of claim 1, wherein the moment imparting device comprises:
a housing attached to the frame of the motorized apparatus;
a spherical mass disposed within the housing and capable of freely rotating within the housing around any diametric axis of the spherical mass; and
a rotation inducing mechanism configured to induce rotation of the spherical mass within the housing around any selected diametric axis.

11. The motorized apparatus with moment imparting device of claim 10, wherein the housing is moveably attached to the frame of the motorized housing.

12. The motorized apparatus with moment imparting device of claim 10, wherein the rotation inducing mechanism comprises:
a plurality of drive wheels rotationally supported in the housing and in contact with the spherical mass, each drive wheel configured to rotate the spherical mass around a distinct diametric axis; and
a control mechanism in communication with each drive wheel and configured to rotate the drives wheels are predetermined speeds to produce a net rotation in the spherical mass about a desired diametric axis.

13. The motorized apparatus with moment imparting device of claim 12, wherein the plurality of drive wheels comprises two drive wheels configured to rotate the spherical mass around two distinct and perpendicular diametric axes.

14. The motorized apparatus with moment imparting device of claim 1, wherein the moment imparting device further comprises sensors to monitor rotation of the motorized apparatus about at least one axis and a control mechanism to configure the moment imparting device to impart a desired induce rotational momentum to the entire motorized apparatus based on the monitored rotation.

15. A motorized apparatus with moment imparting device comprising:
a motorcycle comprising:
a frame;
a motor mounted on the frame; and
a propulsion mechanism supported by the frame and in communication with the motor, the propulsion mechanism comprising two wheels and a drive chain and deriving power from the motor sufficient to propel the motorcycle; and
a moment imparting device attached to the frame of the motorcycle and configured to impart rotational momentum to the entire motorcycle;
wherein the moment imparting device is independent of and separate from the propulsion mechanism of the motorcycle.

16. The motorized apparatus with moment imparting device of claim 15, wherein the moment imparting device is moveably attached to the frame of the motorcycle and further comprises sensors to monitor rotation of the motorcycle about at least one axis and a control mechanism to configure the moment imparting device and to move the moment imparting device relative to the motorcycle frame to impart a desired induced rotational momentum to the entire motorcycle based on the monitored rotation.

17. The motorized apparatus with moment imparting device of claim 15, wherein the moment imparting device is centered on the center of mass of the motorcycle.

18. The motorized apparatus with moment imparting device of claim 15, wherein the moment imparting device comprises:
a plurality of mutually perpendicular rotational axis members;
a plurality of rotational members, each rotational member configured to rotate around one of the plurality of rotational axis members and each rotational axis member having at least one associated rotational member; and
a rotation inducing mechanism configured to induce rotation of the rotational members about the rotational axis members.

19. The motorized apparatus with moment imparting device of claim 18, wherein the moment imparting device comprises:
a housing attached to the frame of the motorcycle;
a spherical mass disposed within the housing and capable or freely rotating within the housing around any diametric axis of the spherical mass; and
a rotation inducing mechanism configured to induce rotation of the spherical mass within the housing around any selected diametric axis.

20. A system for controlling the rotation of a motorized apparatus, the system comprising:
a motor;
a transmission in communication with the motor and deriving rotational motion from the motor;
a plurality of wheels used to propel the motorized apparatus, each wheel in communication with the transmission and deriving rotational motion from the transmission, wherein the transmission is configured to control rotational speed and rotational direction of each wheel separately from and independent of the other wheels; and
a control mechanism in communication with the transmission and configured to use the transmission to separately and independently control the rotational speed and rotational direction of each wheel to impart a desired moment around a selected axis of rotation of the motorized apparatus.
